(19) United States
(12) Patent Application Publication
(10) Pub. No.: US 2013/0086307 A1
(43) Pub. Date: Apr. 4, 2013

(54) INFORMATION PROCESSING APPARATUS, HYBRID STORAGE APPARATUS, AND CACHE METHOD

(71) Applicant: Takehiko Kurashige, Ome-shi (JP)

(72) Inventor: Takehiko Kurashige, Ome-shi (JP)

(21) Appl. No.: 13/450,128

(22) Filed: Apr. 18, 2012

(30) Foreign Application Priority Data
Sep. 30, 2011 (JP) 2011-216570

(51) Int. Cl. G06F 12/08; G06F 12/00

(52) U.S. Cl. 711/103; 711/113; 711/E12.008; 711/E12.019

(57) ABSTRACT

According to one embodiment, an information processing apparatus includes a determination module and a cache module. The determination module is configured to determine whether an access request from a host to the hard disk drive is a request for accessing a preset number of or more consecutive sectors in a hard disk drive. The cache module is configured to use a storage apparatus as a cache for the hard disk drive, and the cache module is configured not to use the storage apparatus as the cache when it is determined that the access request is the request for accessing the preset number of or more consecutive sectors.

### CROSS-REFERENCE TO RELATED APPLICATIONS

This application is based upon and claims the benefit of priority from prior Japanese Patent Application No. 2011-216570, filed Sep. 30, 2011, the entire contents of which are incorporated herein by reference.

### FIELD

Embodiments described herein relate generally to an information processing apparatus, a hybrid storage apparatus, and a cache method, in which the storage apparatus is used as a cache for a hard disk drive.

### BACKGROUND

Compared with improvements in the operation speed of a CPU (Central Processing Unit), improvements in the performance of accessing an HDD (Hard Disk Drive) are slow. Improving the access performance is achieved by using, as a cache, a storage apparatus comprising a flash memory whose access speed is higher than an HDD. For example, a chipset having an S-ATA controller which uses an SSD (Solid State Drive) as a cache for an HDD has been manufactured.

Recently, files of large sizes, such as music and movie files, are frequently transferred between a host and an HDD. Such file transfer is sequential access. A problem may occur when caching is performed for sequential access.

For example, two problems may occur in sequential read access. Data to be sequentially read will be read again in the near future with low possibility. Even if data is read, the data will be sequentially read again with high probability. If sequentially read data is learned by a cache, data which will be read again with high possibility is pushed away, and may therefore result in decrease of a cache hit rate. Since an HDD has a high sequential lead performance, the performance may inversely deteriorate because more learning data is used than when no cache is used.

In sequential write access, the access performance may deteriorate. In general, when an SSD is used as a cache for an HDD, sequential write is performed on the HDD while random write is performed on the SSD. Therefore, as the random write performance of the SSD is lower than sequential read performance of the HDD, the performance can be reduced by writing sequential write access data into the SSD rather than into the HDD.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary block diagram showing an example of a configuration of an information processing apparatus according to the first embodiment.

FIG. 2 is an exemplary block diagram showing an example of a main part of the information processing apparatus according to the first embodiment.

FIG. 3 is an exemplary diagram for explaining an outline of operation when an NVC in FIG. 2 is used as a cache.

FIG. 4 is an exemplary flowchart for explaining operation of performing write-through cache.

FIG. 5 is an exemplary flowchart for explaining operation of write-back cache.

FIG. 6 is an exemplary transition diagram showing operation when read access is made to an HDD from a program.

FIG. 7 is an exemplary diagram of data transition of sequential read detection in read access shown in FIG. 8.

FIG. 8 is an exemplary transition diagram showing operation when read access is made to two HDDs from two programs.

FIG. 9 is an exemplary diagram showing transition of sequential-read detection data in the read access shown in FIG. 8.

FIG. 10 is an exemplary flowchart showing an example of a procedure of detecting sequential read according to the first embodiment.

FIG. 11 is an exemplary flowchart for explaining operation in which learning is not performed in sequential read according to the first embodiment.

FIG. 12 is an exemplary diagram showing transition of sequential-read detection data, according to a modification to the first embodiment.

FIG. 13 is an exemplary flowchart for explaining operation in which learning is not performed in sequential read, according to the second embodiment.

FIG. 14 is an exemplary flowchart for explaining operation in which learning is not performed in sequential read, according to the second embodiment.

FIG. 15 is an exemplary flowchart showing an example of sequential access detection data, according to the third embodiment.

FIG. 16 is an exemplary flowchart showing an example of a procedure for detecting sequential access, according to the third embodiment.

FIG. 17 is an exemplary block diagram showing an example of a configuration of an information processing apparatus, according to the fourth embodiment.

FIG. 18 is an exemplary block diagram showing an example of a main part of the information processing apparatus, according to the fourth embodiment.

FIG. 19 is an exemplary block diagram showing an example of a configuration of an information processing apparatus according to the fifth embodiment.

FIG. 20 is an exemplary block diagram showing an example of a configuration of an information processing apparatus according to the sixth embodiment.

FIG. 21 is an exemplary block diagram showing an example of a configuration of an information processing apparatus according to the seventh embodiment.

### DETAILED DESCRIPTION

Various embodiments will be described hereinafter with reference to the accompanying drawings.

In general, according to one embodiment, an information processing apparatus includes a determination module and a cache module. The determination module is configured to determine whether an access request from a host to the hard disk drive is a request for accessing a preset number of or more consecutive sectors in a hard disk drive. The cache module is configured to use a storage apparatus as a cache for the hard disk drive, and the cache module is configured not to use the storage apparatus as the cache when it is determined that the access request is the request for accessing the preset number of or more consecutive sectors.

### First Embodiment

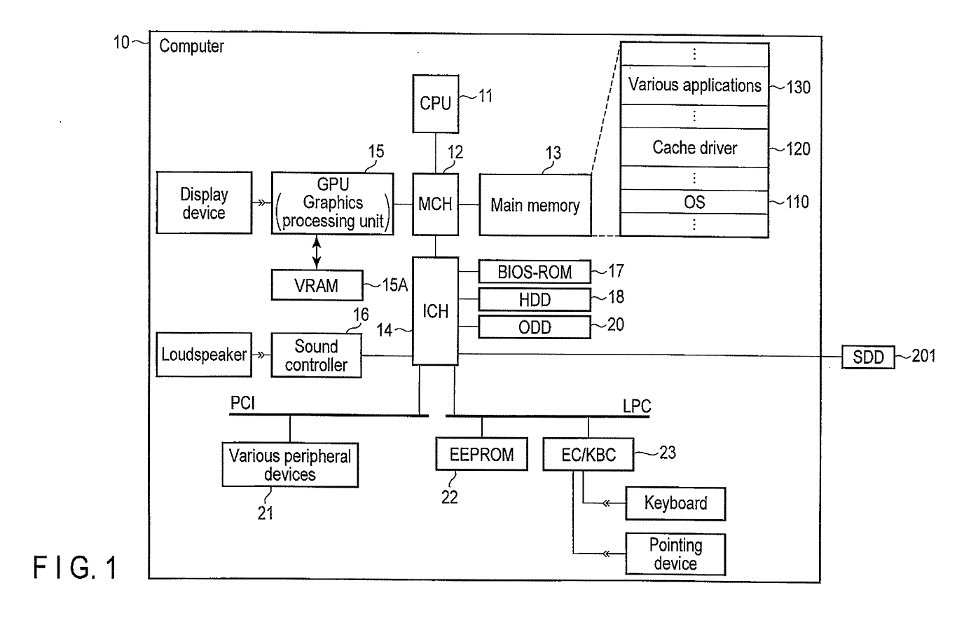

FIG. 1 is a diagram showing a system configuration of an information processing apparatus according to the first embodiment. The information processing apparatus according to the present embodiment is configured as a personal computer.

As shown in FIG. 1, the present information processing apparatus comprises: a CPU (Central processing unit) 11, an MCH (Memory controller hub) 12, a main memory (volatile memory) 13, an ICH (I/O controller hub) 14, a GPU (Graphics processing unit) 15, a video memory (VRAM) 15A, a sound controller 16, a BIOS-ROM (Read only memory) 17, an HDD (Hard disk drive) 18, an ODD (Optical disc drive) 20, various peripheral devices 21, an EEPROM (Electrically erasable programmable ROM) 22, an EC/KBC (Embedded controller/keyboard controller) 23.

The CPU 11 is a processor which controls operation of the present information processing apparatus and performs various programs which are loaded from the HDD 18 and ODD 20 to the main memory 13. Among various programs performed by the CPU 11, there are an operating system (OS) 110 which manages resource control, a cache driver 120 and various application programs 130 which operate under the OS 110. The cache driver 120 is a program which uses an SSD 201, described later, as a cache device. This program causes the connected HDD 18 and another storage apparatus (for example, SSD) to function as a so-called HDD accelerator, by making the HDD 18 and the other storage apparatus to be seen as a storage. Specifically, the HDD accelerator is regarded as a driver which operates on the OS, and the cache driver 120 operates.

The CPU 11 performs a BIOS stored in the BIOS-ROM 17. The BIOS is a program for hardware control. Hereinafter, the BIOS as a stored content in the BIOS-ROM 17 may also be referred to as a BIOS 17 at times.

The MCH 12 operates as a bridge which connects the CPU 11 and the ICH 14, and also operates as a memory controller which performs access control of the main memory 13. The MCH 12 has a function to communicate with the GPU 15.

The GPU 15 is a display controller which is incorporated in the present information processing apparatus or externally connected. The GPU 15 comprises a VRAM 15A.

The ICH 14 comprises an ATA (AT Attachment) controller for controlling the HDD 18 and ODD 20. The ICH 14 also controls the various peripheral devices 21 connected to a PCI (Peripheral component interconnect) bus. The ICH 14 has a communication function to communicate with the sound controller 16.

The sound controller 16 is a sound device, and various programs output audio data to a loudspeaker incorporated in or externally connected to the present information processing apparatus.

The EEPROM 22 is a memory device for storing individual information of the present information processing apparatus and environmental setting information. Further, the EC/KBC 23 is a one-chip MPU (Micro processing unit) which integrates an embedded controller and a keyboard controller for inputting data input by operating a keyboard and a pointing device.

The cache driver 120 uses, as a cache memory for the HDD 18, at least a partial region (NVC (Non-Volatile Cache)) of the SSD 201 and a partial region (L1) of the main memory 13.

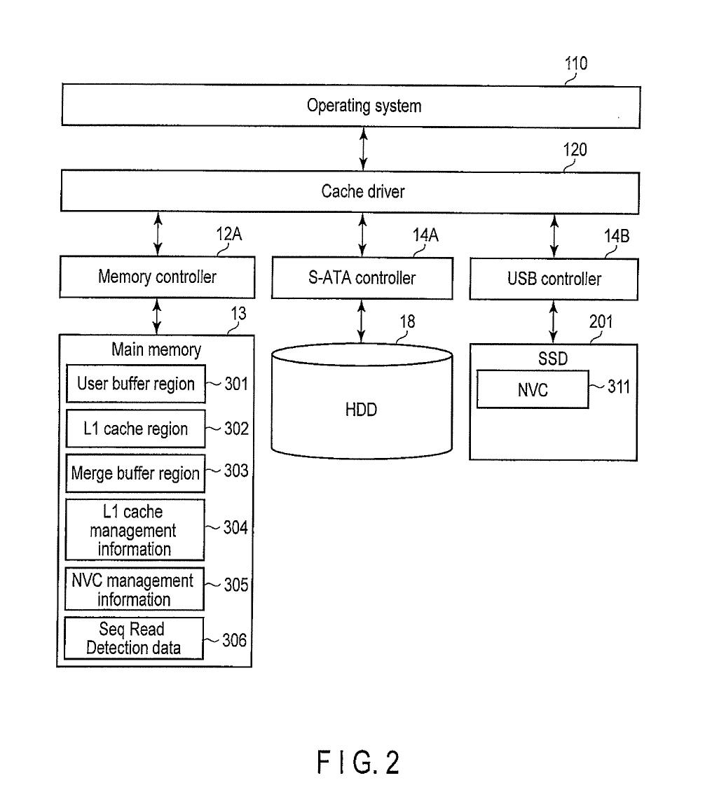

Next, the function of the cache driver 120 will be described with reference to FIG. 2. FIG. 2 is a block diagram showing a main part of the information processing apparatus shown in FIG. 1.

A user buffer region 301, an L1 cache region 302, and a merge buffer region 303 are maintained in the main memory 13. L1 cache management information 304, NVC management information 305, and sequential-read detection data (Seq Read Detection Data) 306 are created in the memory 13 by the cache driver 120.

The L1 cache region 302 is a buffer used together with the NVC 311 as a cache for the HDD 18. The L1 cache region 302 is maintained in the main memory when a filter driver is loaded. The L1 cache region 302 has a capacity of about 16 MB.

The merge buffer region 303 is used when a write-back method is used as a cache method. The merge buffer region 303 is used to temporarily store data which is not stored in the L1 cache region 302 but is read from the HDD 18 when part of data is stored in the L1 cache region 302. The L1 cache management information 304 is information to manage cache data stored in the L1 cache region 302. NVC management information 305 is information to manage cache data stored in the L1 cache region 302. A plurality of entries are set in the NVC management information 305. A storing location of cache data, a storing location of the HDD 18 corresponding to the cache data, and data indicating whether the cache data and data in the HDD 18 correspond to each other are stored in each of the entries. Sequential-read detection data 306 will be described later.

An operating system (OS) 110 controls the information processing apparatus 10. All access from the operating system 110 to the HDD 18 is performed by the cache driver 120. The cache driver 120 directly or indirectly controls a S-ATA controller 14A and a USB controller 14B. The HDD 18 is connected to the S-ATA controller 14A. The SSD 201 is connected to the USB controller 14B. The cache driver 120 performs data access to the main memory 13 through the memory controller 12A.

The cache driver 120 is loaded onto the main memory 13 when the system is started up. The cache driver 120 maintains and initializes a region for storing the L1 cache management information 304, and puts the cache in a state of not recording anything. Thereafter, a cache control processing is started. The L1 cache management information 304 includes data to manage cache data such as a cache directory. When the cache driver 120 is operated, the cache driver 120 records data to manage learning data in a write cache and a read cache, into the L1 cache management information 304 in the main memory 13. After shutdown, the cache driver 120 abandons the L1 cache information in the main memory 13.

Until the cache driver 120 starts operating, a BIOS program controls access to the HDD 18. The S-ATA controller 14A accesses the HDD 18 when a write access request or a read access request is made from a host.

A part or all of the region of the SSD 201 is used as a cache for the HDD 18. The operating system 110 cannot directly access a cache of the SSD 201 used as a storage region for cache data.

The present information processing apparatus improves a speed of accessing the HDD 18 by using, as a cache of the HDD 18, the SSD (Solid State Drive) 201 having a faster access speed and the L1 cache region 302 maintained in the main memory 13. The SSD 201 comprises a flash memory (non-volatile memory).

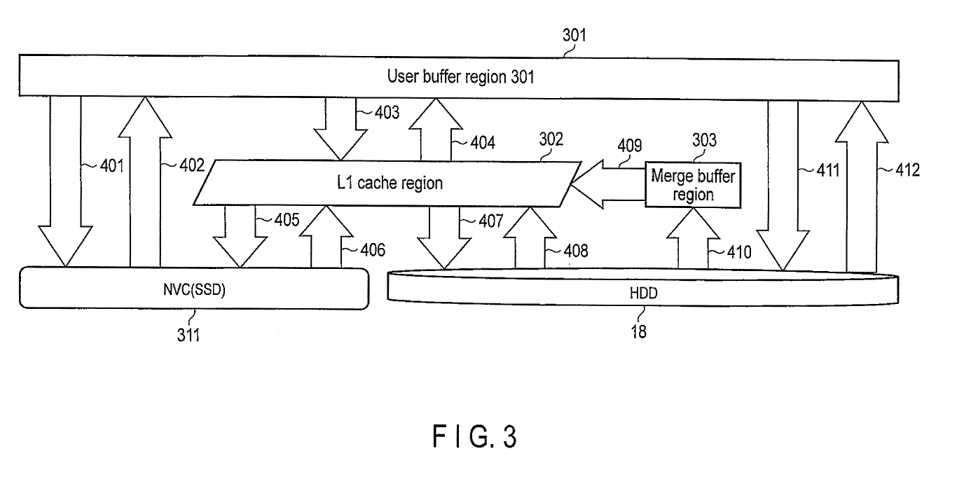

Next, referring to FIG. 3, an outline of operation when using the NVC 311 as a cache will be described.

The cache driver combines twelve data transfers, 401 to 412, and uses the L1 cache region 302 and NVC 311 as a cache for the HDD 18, thereby to improve the access speed of the HDD 18.

### Write-Through Cache

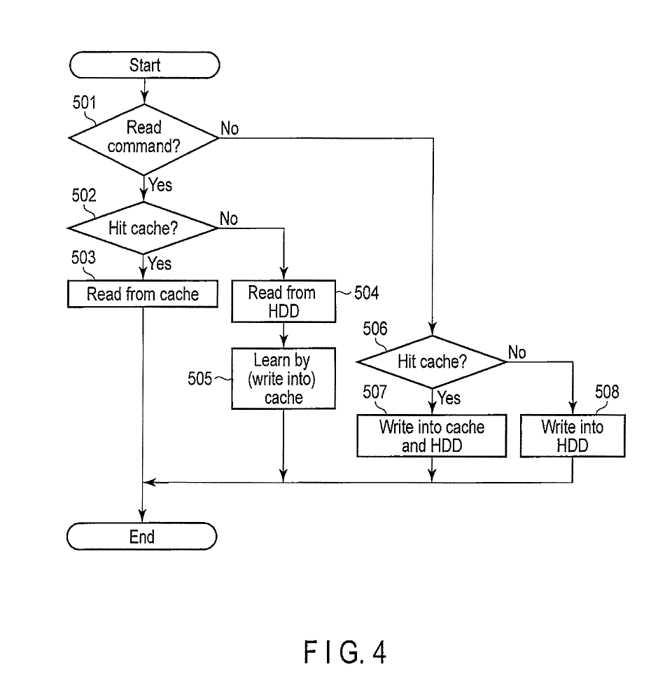

A general operation to perform caching for read access to the HDD will now be described. At first, cache control which is referred to as a write-through cache will be described with reference to FIG. 4.

When an access command from the operating system 110 to the HDD 18 is issued, the cache driver 120 determines whether the issued command is a read command or not (block 501). When a read command is determined (Yes in block 501), the cache driver 120 determines whether data corresponding to the read command exists within the L1 cache region 302 and the NVC 311 in the SSD 202, by referring to the L1 cache information 304 and NVC management information 305 (block 502). When data is determined to exist (Yes in block 502), data corresponding to the read command is read from the L1 cache region 302 or the NVC 311. When data is not determined to exist, the cache driver 120 reads data corresponding to the read command onto the L1 cache region 302, and transfers the data to the user buffer region 301 (block 504). Further, the cache driver 120 writes the data read from the HDD 18, as cache data, into the NVC 311 from the L1 cache region 302, and learns the data (block 505).

In block 501, when the issued command is determined to be not a read command (i.e., a write command) (No in block 501), whether or not data at an address corresponding to the write command exists in the L1 cache region 302 or the NVC 311 in the SSD 202 is determined (block 506). When data is determined to exist in the L1 cache region 302 or NVC 311 (Yes in block 506), cache data existing in the L1 cache region 302 or NVC 311 is rewritten, and data corresponding to the write command is written into the HDD 18 (block 507). When data is determined to not exist in the L1 cache region 302 or NVC 311 (No in block 506), the data corresponding to the write command is written into the HDD 18 (block 508).

In operation of the cache driver when read access is learned, the read operation continues if the read access is to data having an extremely large data volume such as music or a movie. The read operation as described above will now be described as sequential read. In sequential read, two problems of performance and a cache hit rate can possibly occur. Sequentially read data is subjected to sequential data reading, and therefore will be read again with low probability in the future. Even if data is sequentially read, the sequentially read data will be sequentially read again with high probability. If sequentially read data is learned by the NVC 311, a data volume thereof is very large, and pushes away data which has been learned by the NVC 311 and will be read again with high probability. Therefore, the cache hit rate is involved (problem of the cache hit rate). On the other side, in general, the HDD 18 has high sequential read performance. Therefore, the performance of the HDD 18 can, inversely, deteriorate since learning is performed into the NVC 311. Further, when the read performance of the SSD 201 is equal to or lower than the sequential read performance of the HDD 18, no effect of the cache can be expected even if data is read again in the near future and hits a cache (performance problem).

### Write-Back Cache

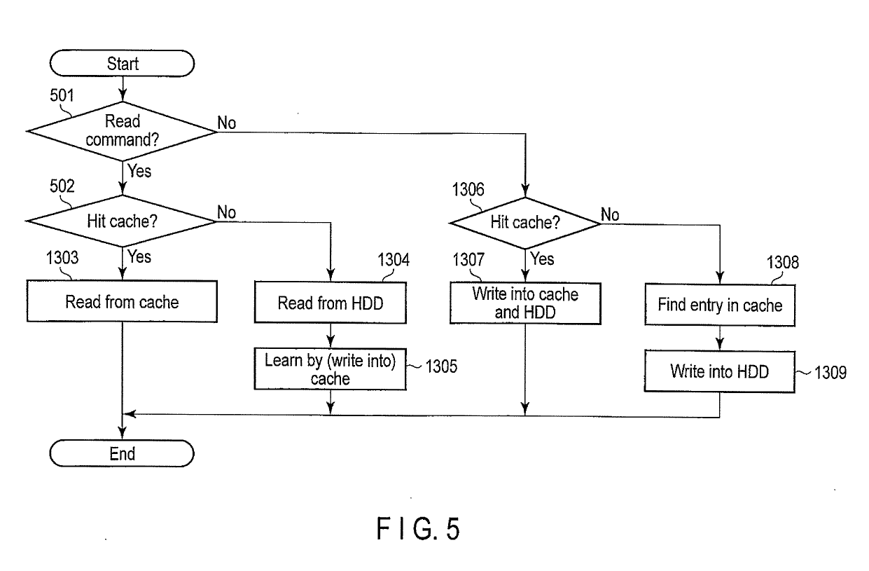

Further, the write-back method is another control method of a general operation of caching for read access to the HDD. Operation according to the write-back cache will be described with reference to FIG. 5.

Blocks 501 to 505 are the same as the cache operation of read as described in FIG. 4. In block 501, when the issued command is determined to be not a read command (i.e., a write command) (No in block 501), whether data at an address corresponding to the write command exists in the NVC 311 in the SSD 202 or not is determined (block 1306). When data is determined to exist in the NVC 311 (Yes in block 1306), the cache driver 120 rewrites data existing in the NVC 311 (block 1307). When data is determined to exist in the NVC 311 (Yes in block 1306), the cache driver 120 rewrites data existing in the NVC 311 (block 1308). The cache driver 120 writes data at an address corresponding to an entry of the found NVC 311 (block 1309).

In the write-back operation as described above, write performance can deteriorate when data to be written is of sequential write. When the random write performance is slower than the sequential read of the HDD 18, the performance deteriorates more by sequential write into the SSD 201 than by direct writing into the HDD 18. This is because, even sequential write into the HDD 18 can be random write into the SSD 201.

### Determination Method for Sequential Access

In order to solve the problem in sequential access as described above, the cache driver 120 according to the present embodiment uses sequential-read detection data 306, in order to determine whether read access is of sequential read or not. In the sequential-read detection data 306, data is a table of n lines. Although the number n of lines is predetermined, n is given as a parameter when the cache driver 120 is started up. Each line is configured by an LRU counter (LRUC), an HDD identification number (HDD), a next LBA (Next LBA) (sector number), and a number (Size) of sectors which have already been read. The LRU counter finds lines which have been used earliest, and takes a value from 0 to n−1 at the time of n lines. The value of 0 indicates the most recently used line, and the value of n−1 is the line used earliest. In this manner, sequential read in the past n processes can be detected.

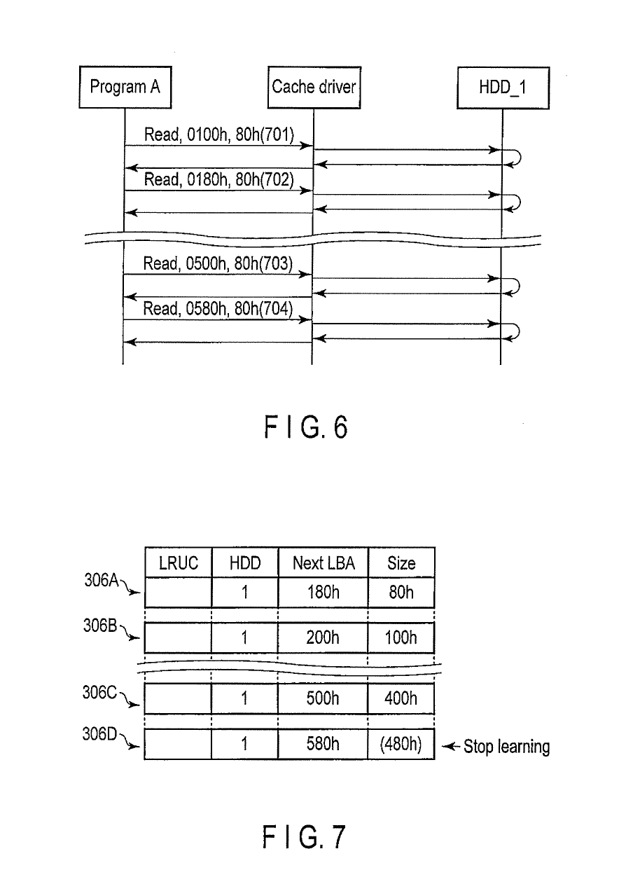

In the present embodiment, it is determined whether sequential read is performed using a table of n lines. At first, as shown in FIG. 6, operation in the case of accessing an HDD (HDD identification number=1) from a program A will be described. A further description will be made of transfer of values in sequential-read detection data 306 (n=1) when read access as shown in FIG. 6 is made. A threshold defining whether the read access is of sequential read or not, i.e., a sequential-read detection size is set to 400h.

At first, by operation of the program A, the CPU 11 issues, to the HDD, a command for read access to data having a sector number of 80h from an address 0100h (“h” is appended to indicate the hexadecimal number system) (block 801). The cache driver 120 generates the sequential-read detection data 306A. In the sequential-read detection data 306A, the HDD identification number is 1, Next LBA is 180h, and the size is 80h.

After requested data is read from the HDD, the CPU 11 issues a command for read access to data from an address 0180h to the sector number 80h (block 802). The cache driver 120 generates sequential-read detection data 306B. In the sequential-read detection data 306B, the HDD identification number is 1, Next LBA is 180h, and the size is 80h.

By operation of the program A, the CPU 11 issues a command for read access to data having a sequential size of 80h each time the read access ends. After requested data is read from the HDD, the CPU 11 issues a command for read access to data from address 0500h to sector number 80h (block 803). The cache driver 120 generates sequential-read detection data 306C. In the sequential-read detection data 306C, the HDD identification number is 1, Next LBA is 180h, and the size is 400h.

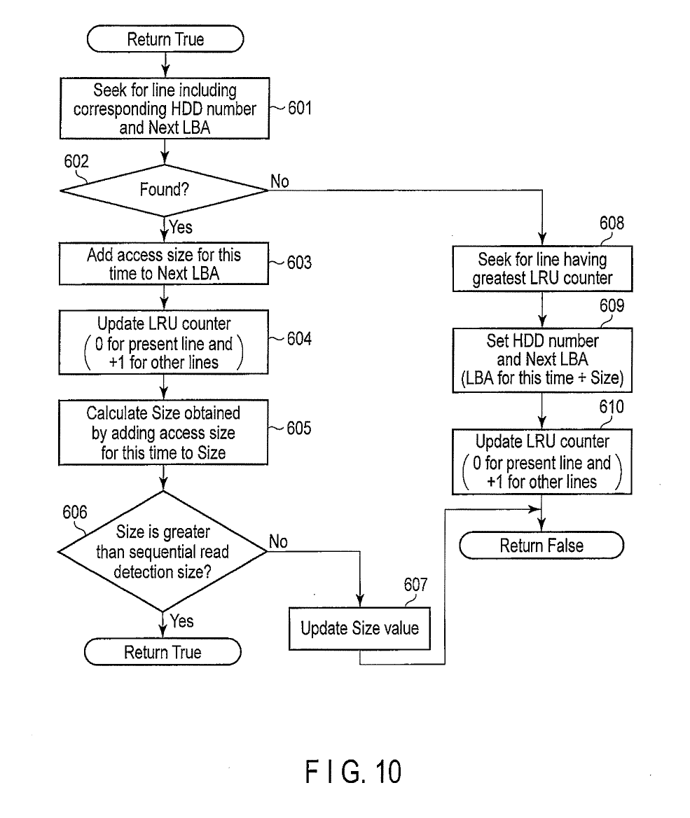

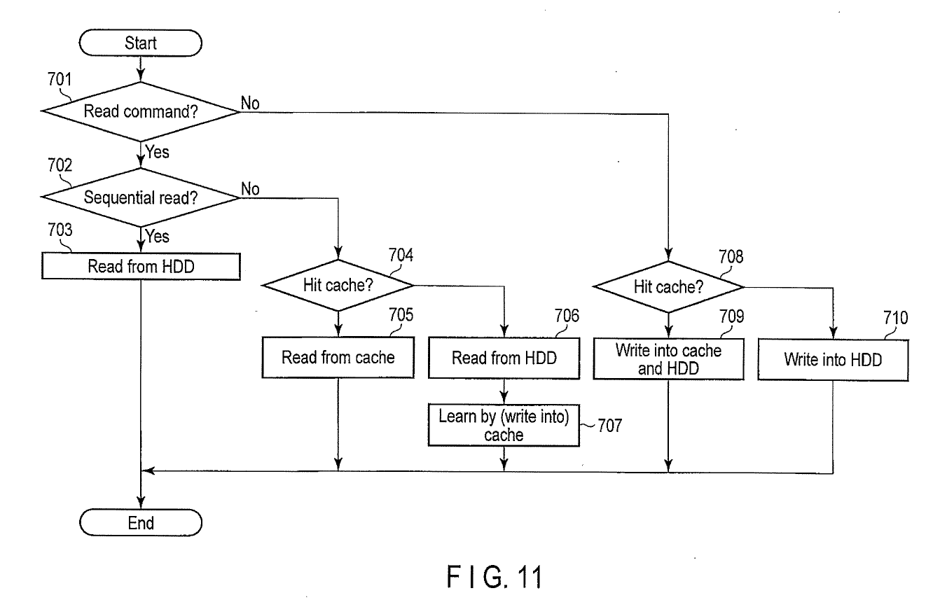

After requested data is read from the HDD, the CPU 11 issues, to the HDD, a command for read access to data from address 0500h to sector number 80h (block 804). The cache driver 120 generates sequential-read detection data 306D. In the sequential-read detection data 306D, the HDD identification number is 1, and Next LBA is 500h. A size calculated in block 605 in a flowchart shown in FIG. 10 is 480h. Further, in block 606 of the flowchart in FIG. 10, the size (480h) is determined to be greater than a sequential-read detection size. Therefore, in block 702 in the flowchart of FIG. 11, the sequential read is determined, and therefore, learning of data subjected to read access is not performed any more.

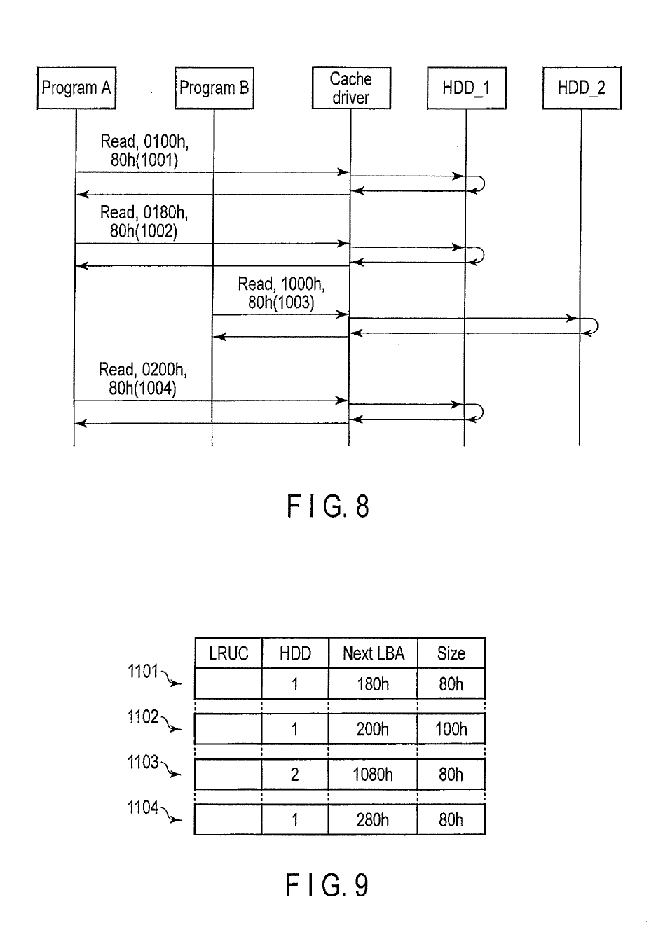

Next, a description will be made where the CPU 11 accesses an HDD_1 (HDD identification number=1) by operation of the program A as shown in FIG. 8 and the CPU 11 accesses an HDD_2 (HDD identification number=2) by operation of the program B. With reference to FIG. 9, a further description will be made of transfer of values in sequential-read detection data (n=1) when read access as shown in FIG. 8 is made. A sequential-read detection size is set to 400h.

At first, by operation of the program A, the CPU 11 issues, to the HDD_1, a command for read access to data from address 0100h to sector number 80h (block 1001). The cache driver 120 generates sequential-read detection data 1101. In the sequential-read detection data 1101, the HDD identification number is 1, Next LBA is 180h, and the size is 80h.

After requested data is read from the HDD, the CPU 11 issues, to the HDD_1, a command for read access to data from address 0180h to sector number 80h (block 1002). The cache driver 120 generates sequential-read detection data 1102. In the sequential-read detection data 1102, the HDD identification number is 1, Next LBA is 200h, and the size is 100h.

After requested data is read from the HDD, the CPU 11 issues, to the HDD_2, a command for read access to data from address 1000h to sector number 80h (block 1003). The cache driver 120 generates sequential-read detection data 1103. In the sequential-read detection data 1103, the HDD identification number is 2, Next LBA is 1000h, and the size is 80h.

By operation of the program A, the CPU 11 issues, to the HDD_1, a command for read access to data from address 0200h to sector number 80h (block 1004). The cache driver 120 generates sequential-read detection data 1104. In the sequential-read detection data 1104, the HDD identification number is 1, Next LBA is 280, and a size is 80h.

An example of a procedure to detect sequential read of the cache driver 120 will be described with reference to the flowchart of FIG. 10. In this flow, an HDD identifier of a read command, LBA (sector number), and a sector number are given as inputs. True (sequential read) or False (non-sequential read) is returned as an output. A sequential-read detection size is predetermined or given as a parameter (for example, 16 MB) when the driver is started up.

The cache driver 120 seeks for a line having an equal HDD identification number for which read access has been issued and an equal Next LBA (sector number), from sequential-read detection data 306 (block 601). When there is a line which satisfies the equality (Yes in block 602), the cache driver 120 adds a present access size (sector number) to the value of next LBA (sector number) (block 603). The cache driver 120 sets the value of the LRU counter of the line which satisfies the equality as described above, and increments values of the other LRU counters on the other lines by +1 (block 604). Further, the cache driver 120 calculates a size obtained by adding a present access size to an access size (sector number) for this time (block 605). The cache driver 120 determines whether the calculated size is greater than a sequential-read detection size as a preset threshold or not (block 606). If the calculated size is determined to be greater than the sequential-read detection size (Yes in block 606), the cache driver 120 returns True as an output. If the sequential-read detection size is determined to be not greater than the sequential-read detection size (No in block 606), the cache driver 120 updates a value of the present size to a calculated value of the size (block 607). Further, the cache driver 120 returns False (non-sequential read) as an output.

When there is no line including an equal HDD identification number for which read access has been issued and an equal next LBA (sector number) (No in block 602), the cache driver 120 detects a line which includes the greatest number of LRU counter values (block 608). The cache driver 120 sets a value corresponding to an HDD whose HDD identification number on a detected line was subjected to read access. A sum of LBA (sector number) for this time and the sector number is set as a value of Next LBA, and an access size (sector number) for this time is set as a value of Size (block 609). Further, the cache driver 120 sets the value of the LRU counter of the line detected in block 608 to 0, and adds +1 to each of the other LRU counter values on the line (block 610). Further, the cache driver 120 returns False (non-sequential read) as an output.

### Description to Operation of Restricting Learning after Detecting Sequential Read

An operation example having a function to restrict learning after detecting sequential read will be described with reference to the flowchart of FIG. 11.

When an access command to the HDD 18 is issued, the cache driver 120 determines whether an issued command is a read command or not (block 701). When the read command is determined (Yes in block 701), the cache driver 120 determines whether the read command is of sequential read or not by the operation flow in FIG. 10 described above. When data is determined to exist in the NVC 311 (Yes in block 702), the cache driver 120 reads data from the NVC 18 (block 703). On the other side, if the sequential read is not determined (No in block 702), the cache driver 120 determines whether data corresponding to the read command exists in the NVC 311 or not (block 704). When data is determined to exist in the NVC 311 (Yes in block 704), the cache driver 120 rewrites data from the NVC 311 (block 705). When data is determined to exist in the NVC 311 (No in block 704), the cache driver 120 rewrites data from the NVC 18 (block 706). Further, the cache driver 120 writes read data onto the NVC 311, and learns data read from the HDD 18 (block 707).

In block 701, when the command is determined to be not a read commend (i.e., a write command) (No in block 701), whether data at an address corresponding to the write command exists in the NVC or not is determined (block 708). When data is determined to exist in the NVC 311 (Yes in block 708), data in the NVC 311 is rewritten, and data corresponding to the write command is written into the HDD 18 (block 709). When data is determined to not exist in the NVC 311 (No in block 708), the data corresponding to the write command is written into the HDD 18 (block 710).

Through the operation described above, data subjected to read access is not learned after detecting sequential read. Accordingly, deterioration of performance and reduction of a cache hit rate can be suppressed.

### Modification to First Embodiment

Even when the program A performs sequential read, the size is reset if another program B performs read access during read access of the program A. Therefore, sequential read cannot be detected. However, when sequential-read detection data includes a table of two lines, sequential read can be detected even if read access is performed from two programs.

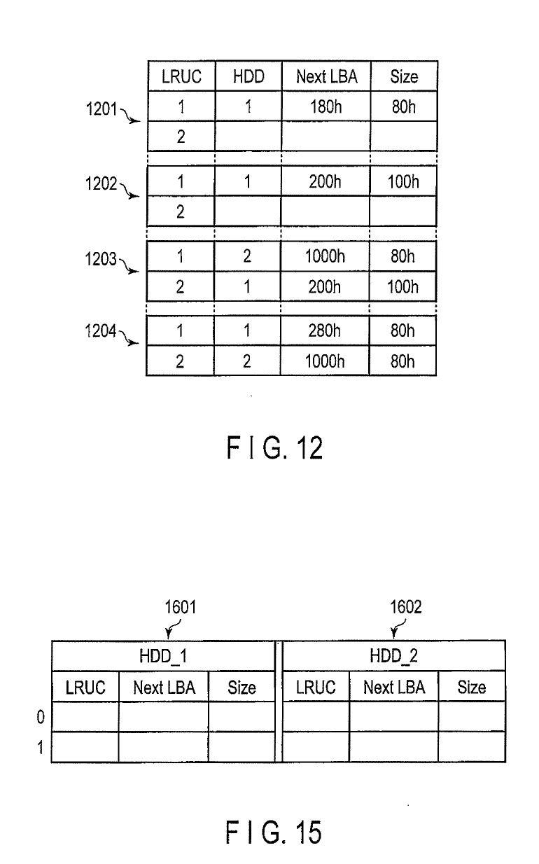

Next, as a modification to the first embodiment, transfer in a form in which sequential-read detection data includes a table of two lines will be described with reference to FIG. 12.

A further description will be made of transfer of values in sequential-read detection data 306 (n=2) when read access as shown in FIG. 8 is made.

At first, by operation of the program A, the CPU 11 issues, to the HDD_1, a command for read access to data from address 0100h to sector number 80h (block 1001). The cache driver 120 generates sequential-read detection data 1201. In the sequential-read detection data 1201, the HDD identification number of a line whose LRUC value is 1 is 1, Next LBA is 180h, and the size is 80h.

After requested data is read from the HDD, the CPU 11 issues, to the HDD_1, a command for read access to data from address 0180h to sector number 80h (block 1002). The cache driver 120 generates sequential-read detection data 1202. In the sequential-read detection data 1202, the HDD identification number of a line whose LRUC value is 1 is 1, Next LBA is 180h, and the size is 80h.

After requested data is read from the HDD, the CPU 11 issues, to the HDD_2, a command for read access to data from address 1000h to sector number 80h (block 1003). The cache driver 120 generates sequential-read detection data 1203. In the sequential-read detection data 1203, the HDD identification number of a line whose LRUC value is 1 is 2, Next LBA is 1000h, and the size is 80h. In the sequential-read detection data 1203, the HDD identification number of a line whose LRUC value is 2 is 1, Next LBA is 1000h, and a size is 100h.

By operation of the program A, the CPU 11 issues, to the HDD_1, a command for read access to data from address 0200h to sector number 80h (block 1004). The cache driver 120 generates sequential-read detection data 1204. In the sequential-read detection data 1204, the HDD identification number of a line whose LRUC value is 1 is 1, Next LBA is 280, and the size is 180h. In the sequential-read detection data 1204, the HDD identification number of a line whose LRUC value is 2 is 2, Next LBA is 1000h, and the size is 80h.

Thus, even if the program B performs read access while the program A performs read access, a value of a size dependent on read access of the program A is not reset but updated. Therefore, sequential read access dependent on read access of the program A can be detected.

### Second Embodiment

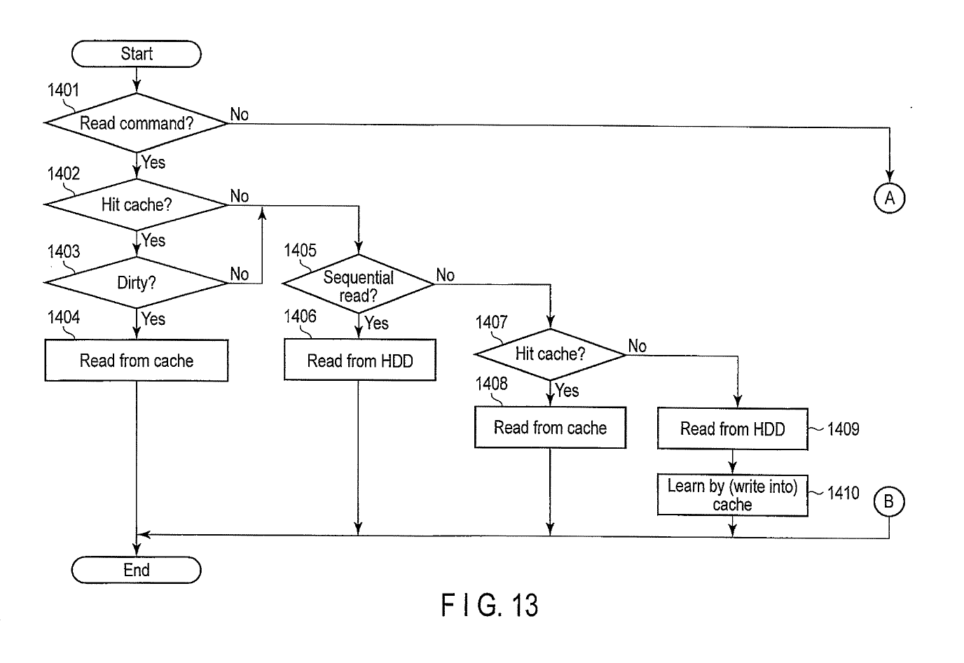

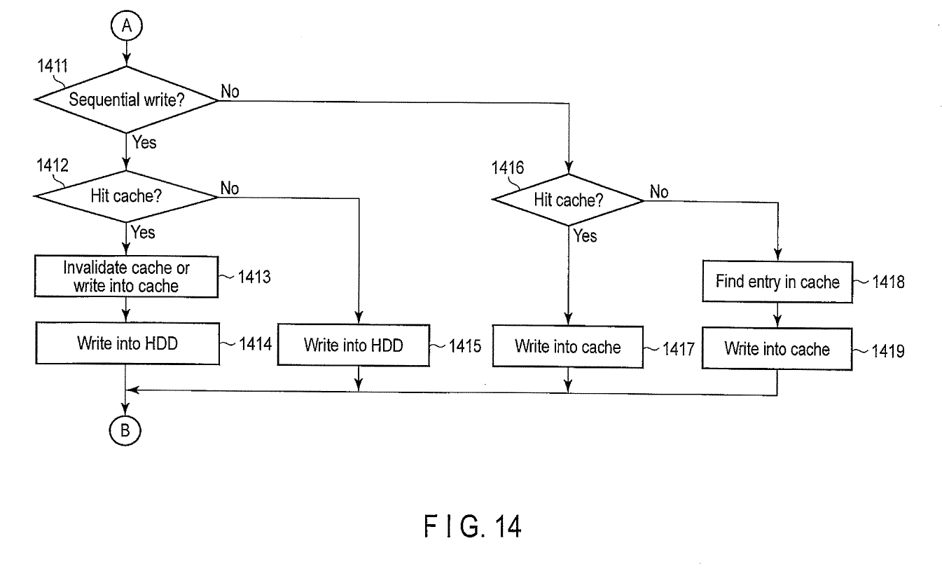

Next, an embodiment which restricts learning into a cache when sequential write is detected will be described as the second embodiment. Operation when learning is not performed for sequential write will be described with reference to FIGS. 13 to 14.

Detection of sequential write is performed in the same manner as detection of sequential read as described with reference to FIG. 10. The cache driver 120 manages sequential-write detection data different from the sequential-read detection data 306.

When an access command from the operating system 110 to the HDD 18 is issued, the cache driver 120 determines whether the issued command is a read command or not (block 1401). When the issued command is determined to be a read command (Yes in block 1401), the cache driver 120 determines whether data corresponding to the read command exists within the L1 cache region 302 and the NVC 311 in the SSD 202, by referring to the NVC management information 305 (block 1402). When data is determined to exist (Yes in block 1402), the cache driver 120 determines whether data in the NVC 311 corresponding to the read command and data in the HDD 18 corresponding to the read command are equal to each other, i.e., whether data in the HDD 18 is dirty or not is determined, by referring to the NVC management information 305 (block 1403). When the data is determined to exist (Yes in block 1403), data corresponding to the read command is read from the L1 cache region 302 or the NVC 311 (block 1404).

When data is determined to not exist (No in block 1402) or when data is determined to be not dirty (No in block 1403), the cache driver 120 determines whether the read access is of sequential read or not (block 1405). When the data is determined to be sequential read (Yes in block 1405), data corresponding to the read command is read from the HDD 18 (block 1406). When data is determined to be not of sequential read (No in block 1405), the cache driver 120 determines whether data corresponding to the read command exists in the NVC 311 or not, by referring to the NVC management information 305 (block 1407). When data is determined to exist (Yes in block 1402), the cache driver 120 reads data corresponding to the read command from the NVC 311 (block 1408). When data is determined to not exist (No in block 1402), the cache driver 120 reads data corresponding to the read command from the HDD 18 (block 1409). The cache driver 120 writes data read from the HDD 18 onto the NVC 311, and learns the data (block 1410).

In block 1401, the command is determined to be not a read command but a write command (No in block 1401), and the cache driver 120 determines whether write access is of sequential write or not, by referring to the NVC management information 305 (block 1411).

When the write access is determined to be sequential write (Yes in block S1411), whether data at an address corresponding to the write command is stored in the NVC 311 or not is determined (block 1412). When data is determined to be stored (Yes in block 1412), the cache driver 120 invalidates data stored in the NVC 311 or overwrites data written in the NVC 311 (block 1413). Further, the cache driver 120 writes the data into the HDD 18 (block 1414).

In block 1412, when data is determined to not exist (No in block 1412), the cache driver 120 writes the data into the HDD 18 (block 1415).

In block 1411, when the issued command is determined to be not a read commend (No in block 1411), whether data at an address corresponding to the write command exists in the NVC 311 or not is determined (block 1416). When data is determined to exist in the NVC 311 (Yes in block 1416), the cache driver 120 rewrites data existing in the NVC 311 (block 1417). When data is determined to not exist in the NVC 311 (No in block 1416), the cache driver 120 finds an entry from the NVC management information 305 (block 1418). The cache driver 120 writes data at an address corresponding to an entry of the found NVC 311 (block 1419).

If the NVC 311 is used as a write-back cache for the HDD 18 in sequential write access through the processing described above, deterioration of sequential write performance can be suppressed by not performing learning.

### Third Embodiment

The first and second embodiments described above each are provided with sequential-read detection data and sequential-write detection data, and detect sequential read and sequential write. As the third embodiment, sequential access detection data is provided for each HDD, and sequential read and sequential write are detected based on the sequential access detection data.

The cache driver 120 manages, as shown in FIG. 15, the sequential access detection data 1601 for the HDD_1 and the sequential access detection data 1602 for the HDD_2. The sequential access detection data 1601 and 1602 each have a data array of two lines, as shown in FIG. 165.

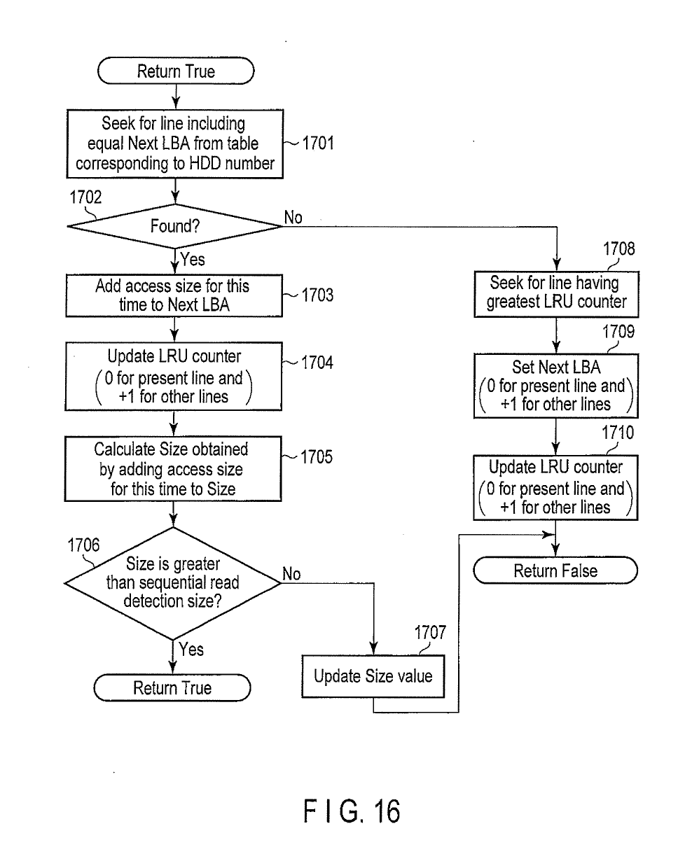

An example of a procedure to detect sequential access of the cache driver 120 will be described with reference to the flowchart of FIG. 16. In this flow, an HDD identifier of a read command, LBA (sector number), and a sector number are given as inputs. True (sequential read) or False (non-sequential read) is returned as an output. A sequential access detection size is predetermined or given as a parameter when the driver is started up (for example, 16 MB).

The cache driver 120 seeks for a next line having equal LBA (sector number) from sequential access detection data in the sequential access detection data 1601 and 1602, corresponding to the HDD to which an access command has been issued (block 1701). When there is a line having equal LBA (Yes in block 1702), the cache driver 120 adds a present access size (sector number) to the value of the next LBA (sector number) (block 1703). The cache driver 120 sets the value of the LRU counter of the line having equal LBA, and increments values of the other LRU counters on the other lines by +1 (block 1704). Further, the cache driver 120 calculates a size obtained by adding a present access size to an access size (sector number) for this time (block 1705). The cache driver 120 determines whether the calculated size is greater than a sequential access detection size as a preset threshold or not (block 1706). If the calculated size is determined to be greater than the sequential access detection size (Yes in block 1706), the cache driver 120 returns True as an output. If the sequential-read detection size is determined to be not greater than the sequential-read detection size (No in block 1706), the cache driver 120 updates a value of the current size to a calculated value of the size (block 1707). Further, the cache driver 120 returns False (non-sequential read) as an output.

When there is no line having an equal HDD identification number to which access has been issued and the next LBA (sector number) are equal to each other (No in block 1702), the cache driver 120 detects a line which includes the greatest number of LRU counter values (block 1708). The cache driver 120 sets a value corresponding to an HDD whose HDD identification number on a detected line has been subjected to read access. A sum of LBA (sector number) for this time and the sector number is set as a value of Next LBA, and an access size (sector number) for this time is set as a value of Size (block 1709). Further, the cache driver 120 sets, to 0, the value of the LRU counter of the line detected in block 1708, and adds +1 to each of the other LRU counter values on the line (block 1710). Further, the cache driver 120 returns False (non-sequential read) as an output.

The sequential access detection data 1601 and 1602 may include an array of one-line data.

A processing using the SSD 201 of the present embodiment as a cache for the HDD 18 is achieved by a computer program. Therefore, the same effects as those of the present embodiment can be easily achieved by simply installing the computer program into an ordinary computer through a storage medium readable from a computer. This computer program can be performed not only by a personal computer but also by an electronic device including a processor.

### Fourth Embodiment

In the above embodiment, the SSD 201 is used as a cache (a read cache and a write-back cache) for the internal HDD. However, the SSD 201 may be used as a cache (a read cache and a write-back cache) for an external storage apparatus connected to an external connection bus for USB or S-ATA. That is, the SSD 201 is used as a cache for the HDD 18 and the external storage apparatus.

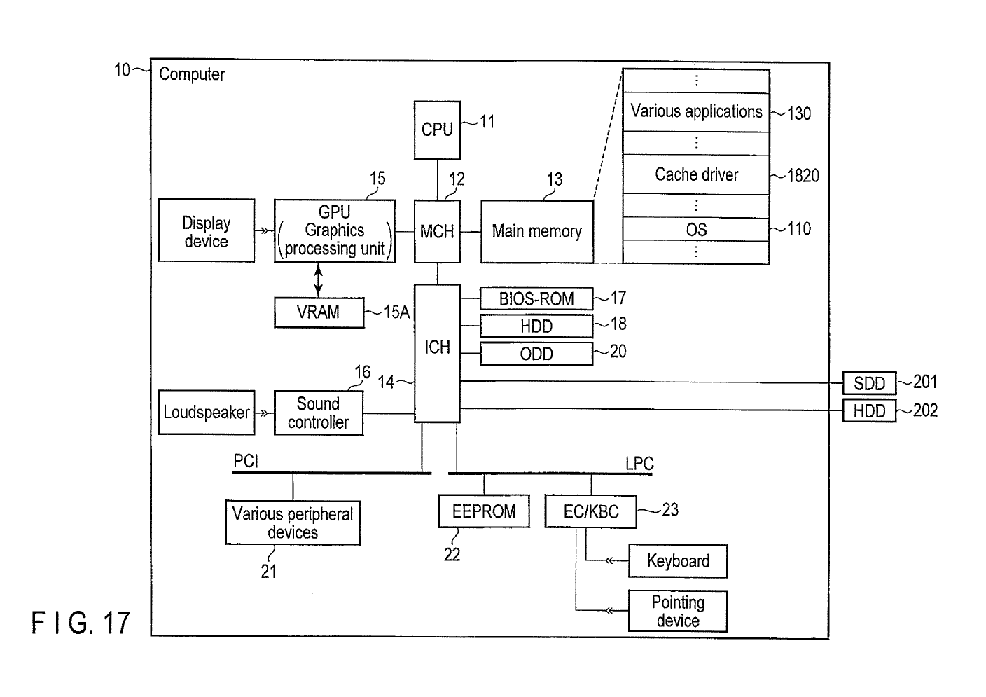

FIG. 17 shows an example of using a USB-HDD as an external storage apparatus. As shown in FIG. 17, a USB-HDD 202 as an external storage apparatus is connected to an ICH 14 having a USB controller. A cache driver 1820 is a program which uses the SSD 201 as a cache device for the HDD 18 and the USB-HDD 202. This is a program that enables functionality as a so-called HDD accelerator, and which improves the response performance by controlling read and write. Specifically, the cache driver 1820 operates by considering the HDD accelerator to act as a driver which operates on the OS. In FIG. 17, the same portions as in FIG. 1 are denoted at the same reference signs, and a description thereof will be omitted.

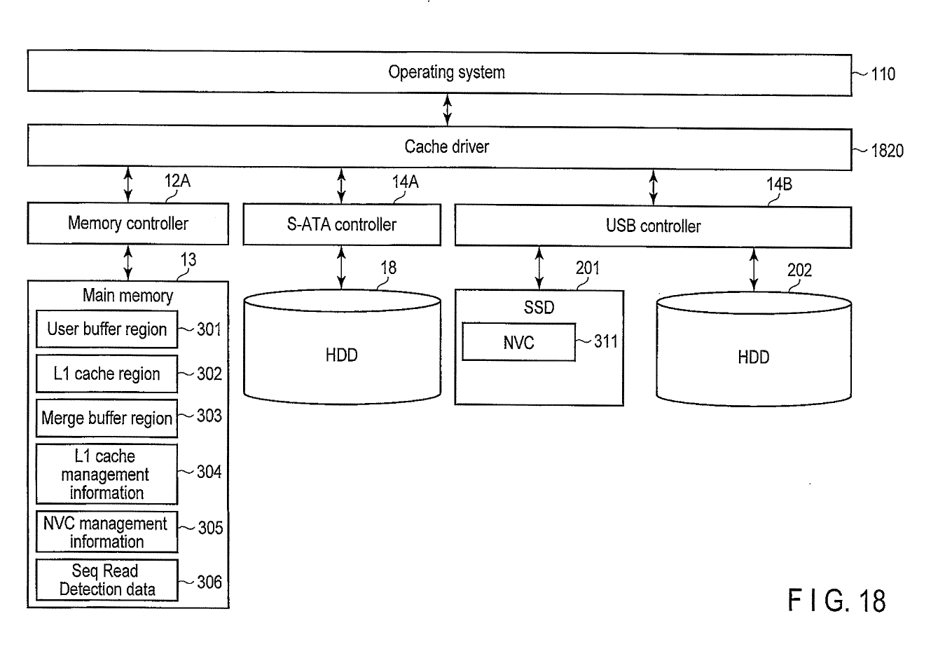

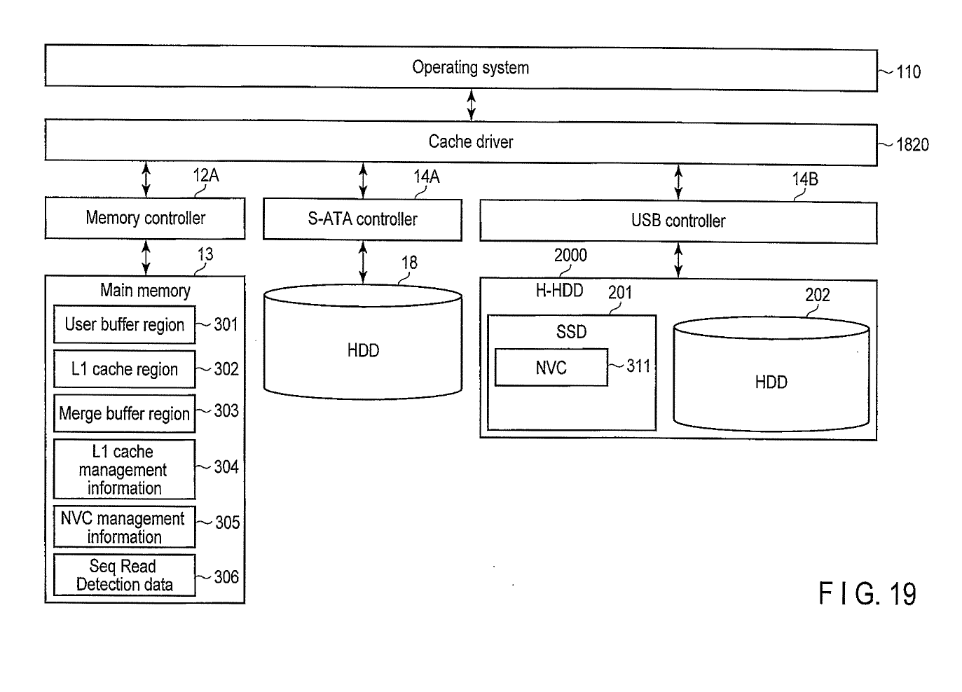

Next, the function of a cache driver 1820 will be described with reference to FIG. 18. FIG. 18 is a block diagram showing a main part of the information processing apparatus shown in FIG. 17. An HDD 18 is connected to an S-ATA controller 14A. The SSD 201 and USB-HDD 202 are connected to the USB controller.

The operating system (OS) 110 controls the information processing apparatus 10, and accesses from the operating system 110 to the HDD 18 and USB-HDD 202 are all performed by the cache driver 1820. The cache driver 1820 directly or indirectly controls the S-ATA controller 14A and USB controller 14B. The cache driver 1820 performs data access to the main memory 13 through the memory controller 12A.

A part or all of the region of the SSD 201 is used as a cache for the HDD 18. The operating system 110 cannot directly access a cache of the SSD 201 used as a storage region for cache data.

The present information processing improves a speed of accessing the HDD 18 and USB-HDD 202 by using, as a cache for the HDD 202 and USB-HDD 202, the SSD (Solid State Drive) 201 having a faster access speed than the HDD 18 and USB-HDD 202.

### Fifth Embodiment

The above fourth embodiment shows an example in which the SSD 201 and USB-HDD 202 are separate. However, the invention is not limited to this example.

The fifth embodiment is applicable to a hybrid hard disk drive 2000 in which an SSD 201 and a USB-HDD 202 are provided in a housing. In the configuration as described above, cache control of the above embodiment can be used.

### Sixth Embodiment

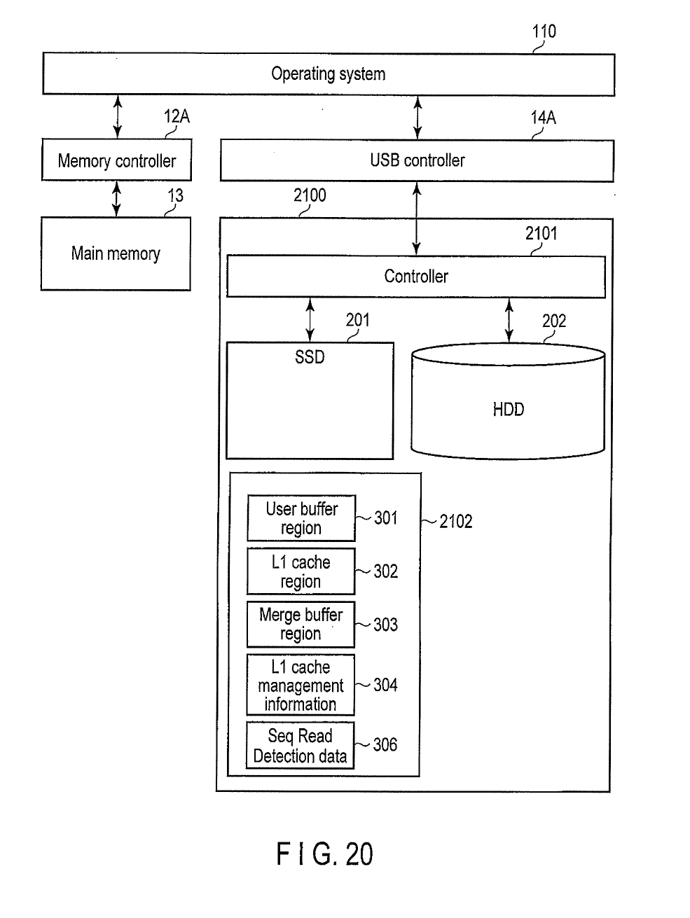

Further, as shown in FIG. 20, the sixth embodiment is applicable to a hybrid hard disk drive (hybrid storage apparatus) 2100 which comprises a controller 2101 and a memory 2102 in addition to the SSD 201 and HDD 202.

In this case, the controller 2101 in the hybrid hard disk drive (hybrid storage apparatus) 2100 performs cache control by using the memory 2102. As shown in FIG. 20, a user buffer region 301, an L1 cache region 302, a merge buffer region 303, an L1-cache buffer region 304, and Seq Read detection data 306 are maintained in the memory 2102.

### Seventh Embodiment

In the sixth embodiment, the controller 2101 uses, as a cache for the HDD 202, the memory 2102 provided in the hybrid hard disk drive (hybrid storage apparatus) 2100. However, the present embodiment is not limited to this configuration.

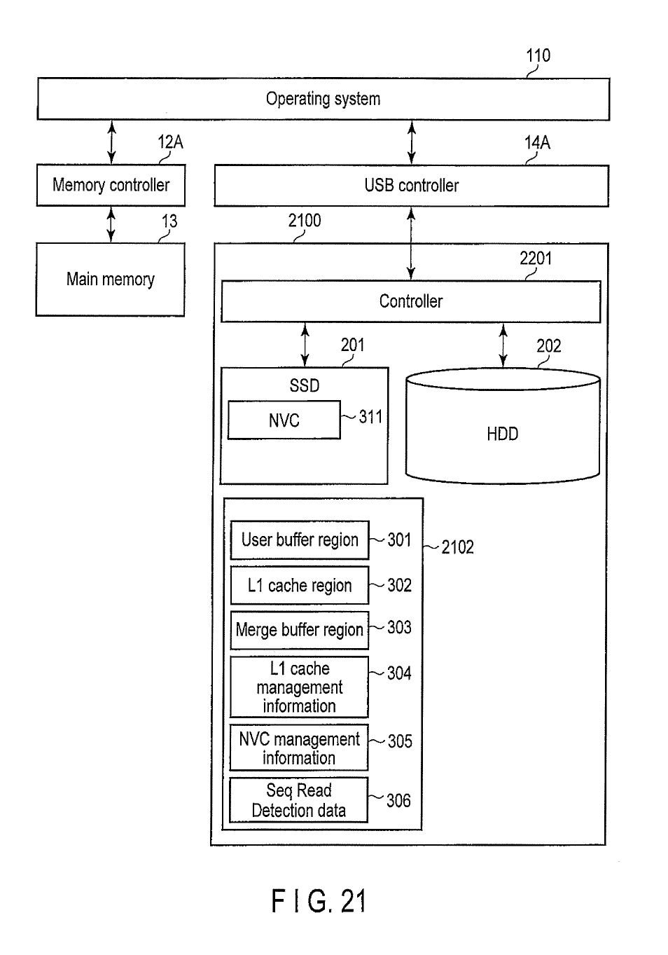

As the seventh embodiment, as shown in FIG. 21, a cache driver of the controller 2201 may use an NVC 311 provided at a part of the SSD 201, as a cache for the HDD 18 and HDD 202.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a determination module configured to determine whether an access request from a host to the hard disk drive is a request for accessing a preset number of or more consecutive sectors in a hard disk drive; and
a cache module configured to use a storage apparatus as a cache for the hard disk drive, and the cache module being configured not to use the storage apparatus as the cache when it is determined that the access request is the request for accessing the preset number of or more consecutive sectors.

2. The apparatus of claim 1, wherein the storage apparatus comprises a flash memory.

3. The apparatus of claim 1, wherein
the determination module is configured to manage management data comprising a next sector number which is next to a last sector number which has been accessed sequentially and a number of sectors which has been accessed sequentially, based on a first sector number and a number of sectors included in a first access command to the hard disk drive,
the determination module is configured to update the sector number and a number of sectors within the management data based on a second access command, when the second access command to access the next sector number is issued next to the first access command,
the determination module is configured to update the sector number and the number of sectors within the management data, based on a third access command, when the third access command to access the next sector number is issued next to the first access command, and
the determination module is configured to determine whether the access request is the request for accessing the preset number of or more consecutive sectors based on the management data.

4. The apparatus of claim 3, wherein
the management data comprises a predetermined number of combinations of the next sector number and the number of sectors, and
the determination module is configured to delete a combination of the next sector number and the number of sectors which are earliest updated in the management data, and to add, to the management data, a next sector number which is next to a last sector number which has been accessed sequentially and a number of sectors which has been accessed sequentially based on the first sector number and a number of sectors which are included in the fourth access command, when the first sector number included in the fourth access command to the hard disk drive is not in the management data.

5. The apparatus of claim 1, wherein
the cache module is configured to determine whether second data stored in a first sector in the sectors subjected to the write access is cached in the storage apparatus, when the access to the hard disk drive is write access and first data is written into the sectors having consecutive sector numbers in the hard disk drive, and
the cache module is configured to inhibit using the second data cached in the storage apparatus as cache data, and the first data is written into the sectors when the second data is determined to be cached in the storage apparatus.

6. The apparatus of claim 1, wherein
the cache module is configured to determine whether third data as cache data of second data stored in a first sector of the sectors is stored in the storage apparatus when the access to the hard disk drive is write access and first data is written into the consecutive sectors of the hard disk drive, and
the cache module is configured to overwrite the third data with fourth data written into the first sector by the write access, and to write data defined by removing the fourth data from the first data into the sectors except the first sector, when it is determined that the third data is stored in the storage apparatus.

7. A hybrid storage apparatus comprising a hard disk drive and a storage apparatus;
a determination module configured to determine whether an access request from a host to the hard disk drive is a request for accessing a preset number of or more consecutive sectors in a hard disk drive; and
a cache module configured to use a storage apparatus as a cache for the hard disk drive, and the cache module being configured not to use the storage apparatus as the cache when it is determined that the access request is the request for accessing the preset number of or more consecutive sectors.

8. The apparatus of claim 7, wherein the storage apparatus comprises a flash memory.

9. The apparatus of claim 7, wherein
the determination module is configured to manage management data comprising a next sector number which is next to a last sector number which has been accessed sequentially and a number of sectors which has been accessed sequentially, based on a first sector number and a number of sectors included in a first access command to the hard disk drive,
the determination module is configured to update the sector number and a number of sector within the management data based on a second access command, when the second access command to access the next sector number is issued next to the first access command,
the determination module is configured to update the sector number and the number of sectors within the management data, based on a third access command, when the third access command to access the next sector number is issued next to the first access command, and
the determination module is configured to determine whether the access request from a host to the hard disk drive is the request for accessing the preset number of or more consecutive sectors based on the management data.

10. The hybrid storage apparatus of claim 9, wherein
the management data comprises a predetermined number of combinations of the next sector number and the number of sectors, and
the determination module is configured to delete a combination of the next sector number and the number of sectors which are earliest updated in the management data, and to add, to the management data, a next sector number which is next to a last sector number which has been accessed sequentially and a number of sectors which has been accessed sequentially based on the first sector number and a number of sectors which are included in the fourth access command, when the first sector number included in the fourth access command to the hard disk drive is not in the management data.

11. The hybrid storage apparatus of claim 7, wherein
the cache module is configured to determine whether second data stored in a first sector in the sectors subjected to the write access is cached in the storage apparatus, when the access to the hard disk drive is write access and first data is written into the sectors having consecutive sector numbers in the hard disk drive, and
the cache module is configured to inhibit using the second data cached in the storage apparatus as cache data, and the first data is written into the sectors when the second data is determined to be cached in the storage apparatus.

12. The hybrid storage apparatus of claim 7, wherein
the cache module is configured to determine whether third data as cache data of second data stored in a first sector of the sectors is stored in the storage apparatus when the access to the hard disk drive is write access and first data is written into the consecutive sectors of the hard disk drive, and
the cache module is configured to overwrite the third data with fourth data written into the first sector by the write access, and to write data defined by removing the fourth data from the first data into the sectors except the first sector, when it is determined that the third data is stored in the storage apparatus.

13. A cache method which uses a storage apparatus as a cache for a hard disk drive, the method comprising
determining whether an access request from a host to the hard disk drive is a request for accessing a preset number of or more consecutive sectors in a hard disk drive; and
a cache module configured to use a storage apparatus as a cache for the hard disk drive, and the cache module configured not to use the storage apparatus as the cache when it is determined that the access request is the request for accessing the preset number of or more consecutive sectors.
not using the storage apparatus as a cache when it is determined that the access request is the request for accessing the preset number of or more consecutive sectors.

14. The cache method of claim 13, wherein the storage apparatus comprises a flash memory.

15. The cache method of claim 13, wherein
the determining comparing:
managing management data comprising a next sector number which is next to a last sector number which has been accessed sequentially and a number of sectors which has been accessed sequentially, based on a first sector number and a number of sectors included in a first access command to the hard disk drive;
updating the sector number and a number of sectors within the management data based on a second access command, when the second access command to access the next sector number is issued next to the first access command;
updating the sector number and the number of sector within the management data, based on a third access command, when the third access command to access the next sector number is issued next to the first access command; and
determining whether the access request is the request for accessing the preset number of or more consecutive sectors.

16. The method of claim 15, wherein
the management data comprises a predetermined number of combinations of the next sector number and the number of sectors, and
the method further comprising:
deleting a combination of the next sector number and the number of sectors which are earliest updated in the management data when the first sector number included in the fourth access command to the hard disk drive is not in the management data; and
adding, to the management data, a next sector number which is next to a last sector number which has been accessed sequentially and a number of sectors which has been accessed sequentially based on the first sector number and a number of sectors which are included in the fourth access command.

17. The cache method of claim 13, further comprising:
determining whether second data stored in a first sector in the sectors subjected to the write access is cached in the storage apparatus, when the access to the hard disk drive is write access and first data is written into the sectors having consecutive sector numbers in the hard disk drive; and
inhibiting to use the second data cached in the storage apparatus as cache data, and the first data is written into the sectors when the second data is determined to be cached in the storage apparatus.

18. The cache method of claim 13, further comprising:
determining whether third data as cache data of second data stored in a first sector of the sectors is stored in the storage apparatus when the access to the hard disk drive is write access and first data is written into the consecutive sectors of the hard disk drive; and
overwriting the third data with fourth data written into the first sector by the write access, and writing data defined by removing the fourth data from the first data into the sectors except the first sector, when it is determined that the third data is stored in the storage apparatus.
